(19) United States
(12) Patent Application Publication
(10) Pub. No.: US 2011/0170681 A1
(43) Pub. Date: Jul. 14, 2011

(54) ON HOLD CALL BACK TELEPHONE FEATURE

(76) Inventors: Ryan Kole, Chicago, IL (US); Thomas Crosley, Gilbert, AZ (US)

(21) Appl. No.: 13/062,662

(22) PCT Filed: Sep. 8, 2009
(86) PCT No.: PCT/US09/56158

§ 371 Date: Mar. 7, 2011

Related U.S. Application Data
(60) Provisional application No. 61/095,050, filed on Sep. 8, 2008.

(51) Int. Cl. H04M 1/00

(52) U.S. Cl. 379/162

(57) ABSTRACT

A telephone system provides an alternative to being kept “on hold”. When placed on hold, *8 or some can be dialed, which allows the party placed on hold to hang up his or her phone without disconnecting the call. To resume the call, the party that placed the call on hold dials any number on his or her phone and the phone of the party that had been placed on hold rings to signify that the call is off hold and can be resumed. When the call back is answered the call is resumed. In a first embodiment, the callback on hold operation is performed in cooperation with a telecommunication company's central office switch. In a second embodiment, dedicated circuitry and microprocessor firmware are added to consumer telephone equipment, performing the callback on hold operation without requiting any specific support from a central office switch. The present invention is disclosed in the environments of telephones, answering machines, combination telephone and answering machines, both corded and cordless telephones (with or without answering machines), cellular telephones, and standalone devices attachable between a telephone and/or answering system and the central office telephone lines. A “hold on hold” indicator lamp may optionally be employed. The indicator lamp circuitry detects brief DTMF tone pairs to signal the operation of a hold LED with a unique cadence indicating of a callback hold, rather than a normal hold condition.

### CROSS-REFERENCE TO RELATED APPLICATION

This application claims the benefit of U.S. Provisional Patent Application No. 61/095,050, filed Sep. 8, 2008, the entirety of which is incorporated herein by reference.

### BACKGROUND OF THE INVENTION

1. Field of the Invention

The present invention relates, in general, to telephony and, more particularly, to an apparatus and a method for providing a call back or signal to a party placed on hold when a call is taken off hold.

2. General Background of the Invention In conventional telephony systems, one party placed on hold by the other party upon initial connection, such as when a receiver of a telephone call places the caller on hold, the party placed on hold must simply wait for the hold to be removed, This inconveniences the caller placed on hold, and can result in the accrual of significant connect-time charges even though no meaningful communication is taking place during the time spent on hold.

### BRIEF SUMMARY OF THE INVENTION

The following is a summary of the various ways the “Callback on Hold” feature, could be implemented as a stand-alone end-user device, or applied to telephone central offices (CO), Voice over Internet Protocol (VoIP), private branch exchanges (PBX), corded and cordless telephones, and cellular phone systems.

There are several variations of the invention that apply to end-user devices, including standalone devices, a part of a standalone telephone set, a part of a telephone answering system connected to a separate corded telephone set, a part of a telephone answering system with an integrated telephone set, a part of a cordless telephone system (with or without an answering machine), a part of a cellular telephone.

When implemented as a standalone device, this device would be stored within its own box, or housing, placed between the subscriber's phone line coming from the central office (CO), and each of their phones. The circuitry consists of a common section, including a CO hold circuit, control logic (or microprocessor), various tone generators and decoders, voice playback units, ringing generator, and power supply; and a per-line section, with line sense and select circuits. The circuit may have just one line circuit, with all the phones attached to it in parallel. However this will limit some of the multi-phone features of the invention. If multiple phones are to be connected, normally there would be a separate line circuit per phone. The various tone generators and decoders and voice playback units could be implemented as either separate circuits, or done via software using a Digital Signal Processor (DSP).

When implemented as part of a standalone electronic telephone set, which would be connected to the subscriber's phone line coming from the central office (CO), the added circuitry needed for the Callback on Hold functionality consists of a CO hold circuit; control logic (typically a microprocessor); Digital Signal Processor (DSP), which implements various tone generators, decoders and voice playback units in software; Analog to Digital converters (ADCs), Digital to Analog Converters (DACs) and amplifiers; ringing generator; and power supply. The telephone set includes a dedicated button to initiate the Callback on Hold function, and an LED to indicate when a call is placed on callback hold. This same LED would be lit with a different cadence to support the “Hold on Hold Lamp Indication” described below.

When implemented as part of a telephone answering system connected to a separate corded telephone set, which would be connected to the subscriber's phone line coming from the central office (CO), and also to a separate corded telephone set, assuming the existing answering machine circuit is using a microprocessor control and Digital Signal Processor (DSP), most of the functionality for Callback on Hold would be implemented as additions to the software in the answering machine. The added circuitry needed consists of line select and off-hook relays; circuitry to pass audio back and forth between the answering machine control unit and the attached telephone set; a ringing generator; and a power supply.

When implemented as part of a telephone answering system with an integrated telephone set connected to the subscriber's phone line coming from the central office (CO), that includes an integrated telephone set (i.e. it has a handset), assuming the existing telephone answering system circuit is using a microprocessor control and Digital Signal Processor (DSP), virtually all of the functionality for Callback on Hold would be implemented as additions to the software in the answering machine. The only additional hardware needed would be a dedicated button to initiate the Callback on Hold function, and an LED to indicate when a call is placed on callback hold. This same LED would be lit with a different cadence to support the “Hold on Hold Lamp Indication” described below

When implemented as part of a cordless telephone system (with or without an answering machine) connected to the subscriber's phone line coming from the central office (CO), the cordless telephone system may or may not have an integrated telephone answering system. Assuming the existing cordless telephone system circuit is using a microprocessor control and Digital Signal Processor (DSP), all of the functionality for Callback on Hold would be implemented as additions to the software in the cordless telephone system (if the cordless system does not include a telephone answering system, flash memory would be need to be added to store audio messages for playback). The only additional hardware needed would be a dedicated button on the handset to initiate the Callback on Hold function if desired. It is assumed the handset display would indicate when a call is placed on callback hold. This same display would also output a message to support the “Hold on Hold Lamp Indication” described below.

When implemented as part of a cellular phone, assuming the cellular phone circuit is using a microprocessor control and Digital Signal Processor (DSP), all of the functionality for Callback on Hold would be implemented as additions to the software in the cellular phone. It is assumed the Callback on Hold function would be initiated either via a dedicated button on the keypad (assigned via software), or through a menu. It is also assumed the phone display would indicate when a call is placed on callback hold. This same display would also output a message to support the “Hold on Hold Lamp Indication” described below.

In each of these scenarios above for the end-user, while sending a message to the party placed on callback hold, two DTMF tone pairs would be sent to provide the Hold on Hold Lamp Indication as described below. The hold on hold lamp indication is essentially a separate invention related to the Callback on Hold feature, and allows a lamp at one end of a telephone call (the called end) to be controlled by the other end (calling end) via tone signals, for the purpose of indicating a “callback on hold” condition on the called subscriber's telephone set.

The invention makes use of the fact that there are actually sixteen DTMF (dual-tone multi-frequency) tone pairs defined for the US telephone network, not just the twelve that appear on virtually all telephone sets (0-9, * and #). The four extra tone pairs are called ‘A’, ‘B’, ‘C’, and ‘D’, and have been used mostly for military applications. However most DTMF transmitter and receiver integrated circuits can both generate and receive the extra frequency pairs.

If implemented as a stand-alone device, the circuitry would consist of a line interface, a Dual-Tone Multi-Frequency (DTMF) receiver, a low-end microprocessor, and an LED. If implemented within an existing telephone set, the line interface would already exist and the remaining circuitry could be added at a relatively nominal incremental cost. The invention could also be implemented as part of the various end-user Callback on Hold variations as described above.

When implemented in conjunction with a telephone central office, the Callback on Hold feature can be implemented on any stored-program control (SPC) telephone switch within the central office. Since the call processing functions of such a switch are handled entirely in software, the Callback on Hold feature can just be added to the call processing software—no additional hardware is required. However because all of the subscriber's phones will be connected together to the central office on one line, this will limit the multi-phone features of the invention (e.g. no selective ringing of just the phone that placed the call on hold). While sending a message to the party placed on callback hold, two DTMF tone pairs would be sent to provide the Hold on Hold Lamp Indication as described above.

When implementing the present invention using Voice over Internet Protocol, it should be noted that there are several different ways implementing VoIP service in common use today. The most common method is to use an analog telephone adapter (ATA), connected between a standard phone and a computer or directly to an Internet connection. The easiest way to add the Callback on Hold feature to an ATA-connected phone would be to use the end-user version of the device described above, in between the analog phone and the ATA. The other way would be to include the feature within the ATA itself, since the device already has much of the circuitry required.

The second type of VoIP is to use Internet Protocol (IP) phones, which have an RJ-45 Ethernet connector instead of traditional RJ-11 telephone connector. Wi-Fi IP phones allow a subscriber to make VoIP calls using any Wi-Fi hot spot. Obviously, it would not be possible to use the standard end-user version of the Callback on Hold feature with either of these types of phones. The only way to add the Callback on Hold feature would be to include the feature within the phone itself.

The third type of VoIP is a direct computer connection using a headset and microphone; no phone is involved. Since this solution is entirely software-driven from within the PC, it would be possible to add the Callback on Hold feature by modifying the softphone software being used.

So the implementation of the Callback on Hold feature for VoIP to VoIP calls in general requires modifications to the endpoint devices, whether hardware, software or a combination of the two.

In each case, while sending a message to the party placed on callback hold, two DTMF tone pairs would be sent to provide the Hold on Hold Lamp Indication as described above.

When implementing the present invention in conjunction with a Private Branch Exchange, PBXs operate as a connection between a business or other organization and the public switched telephone network. In the case of older, analog PBX's it would in general be possible so add the standard end-user version of the Callback on Hold feature to a PBX line. However, digital PBX's often use proprietary digital phones unique to the particular vendor, so it would not be possible to add the standard end-user version of the Callback on Hold feature to a digital PBX extension. In any case, it would be much more efficient to add the feature to the entire switch via a software upgrade to the call processing software and make it available to all users. One variation with a PBX that has proprietary digital phones with programmable feature keys would be to have the Callback on Hold feature assigned to a key, so instead of dialing * 8 the user would just press a key. While sending a message to the party placed on callback hold, two DTMF tone pairs would be sent to provide the Hold on Hold Lamp Indication as described above.

When implementing the present invention in conjunction with a cellular telephone system, one approach is the MTSO version. Cellular phones in the United States use one of three air technologies known as Code Division Multiple Access (CDMA), Time Division Multiple Access (TDMA), or Global System for Mobile communications (GSM, a variation of TDMA). The equivalent to the central office in the cellular telephone network is the Mobile Telephone Switching Office (MTSO), also referred to as the Mobile Switching Center (MSC).

The MTSO handles all connections between the cellular phone customers and the normal land-based stations in the area, as well as connecting to the Internet for VoIP service. Since the Callback on Hold feature is related just to call processing, it is independent of the type of cellular system and would be implemented as an addition to the call processing software in the MTSO or MSC, much the same as described earlier for the central office.

While sending a message to the party placed on callback hold, two DTMF tone pairs would be sent to provide the Hold on Hold Lamp Indication as described above.

Note that this implementation is distinct from the “End User Cellular Phone” implementation described earlier. The former is implemented via software changes to the cellular phone itself, and does require any changes to the MTSO software.

### BRIEF DESCRIPTION OF THE SEVERAL VIEWS OF THE DRAWINGS

FIG. 1 is a schematic flow chart of one embodiment of the present invention, involving, in part, the use of a telecommunications central office switch, such as, for example, a “5ESS switch or No. 5 ESS”, and showing, in particular what happens when you are placed “on hold” during a call and then you use the *8 feature of the present invention to hang up the phone without disconnecting the call;

FIG. 2 is a schematic flow chart of the embodiment of FIG. 1 of the present invention and showing, in particular, what happens when you put the other person “on hold” during a call and the other party uses the *8 feature of the present invention to hang up the phone without disconnecting the call;

FIG. 3 is a schematic diagram of circuitry implementing the “callback on hold” feature of the embodiment of FIG. 1 of the present invention;

FIG. 4 is a block diagram of a typical No. 5 ESS, used to illustrate the implementation of the “Callback on Hold” feature of the first embodiment of the present invention involving, in part, the use of a telecommunication central office switch;

FIG. 5 is a schematic diagram of circuitry implementing a second embodiment of the present invention, capable of performing “on-hold call back” without any required cooperation from a central office switch, implemented as an additional feature of a cellular telephone;

FIG. 6 is a schematic diagram of circuitry of the second embodiment of the present invention implemented as an additional feature of an electronic telephone;

FIG. 7 is a schematic diagram of a visual “hold on hold” indicator for use with the second embodiment of the present invention;

FIG. 8 is a schematic diagram of circuitry implementing the second embodiment of the present invention as an additional feature of a stand-alone answering machine;

FIG. 9 is a schematic diagram of circuitry implementing the second embodiment of the present invention implemented as an additional feature of an answering machine integrated with a telephone set;

FIG. 10 is a schematic diagram of circuitry of the base unit portion of a cordless telephone answering system having the second embodiment of the present invention implemented as an additional feature;

FIG. 11 is a schematic diagram of circuitry of the handset portion of a cordless telephone answering system having the second embodiment of the present invention implemented as an additional feature; and

FIG. 12 is a schematic diagram of circuitry implementing the second embodiment of the present invention, wherein a separate digital signal processing integrated circuit is employed, apart from the control unit.

### DETAILED DESCRIPTION OF THE INVENTION

While the present invention is susceptible of embodiment in many different forms, there is shown in the drawings and will herein be described in detail, several specific embodiments, with the understanding that the present disclosure is intended as an exemplification of the principles of the present invention and is not intended to limit the invention to the embodiments illustrated. Within the various illustrated embodiments, common reference numerals have been assigned to similar or analogous elements and components.

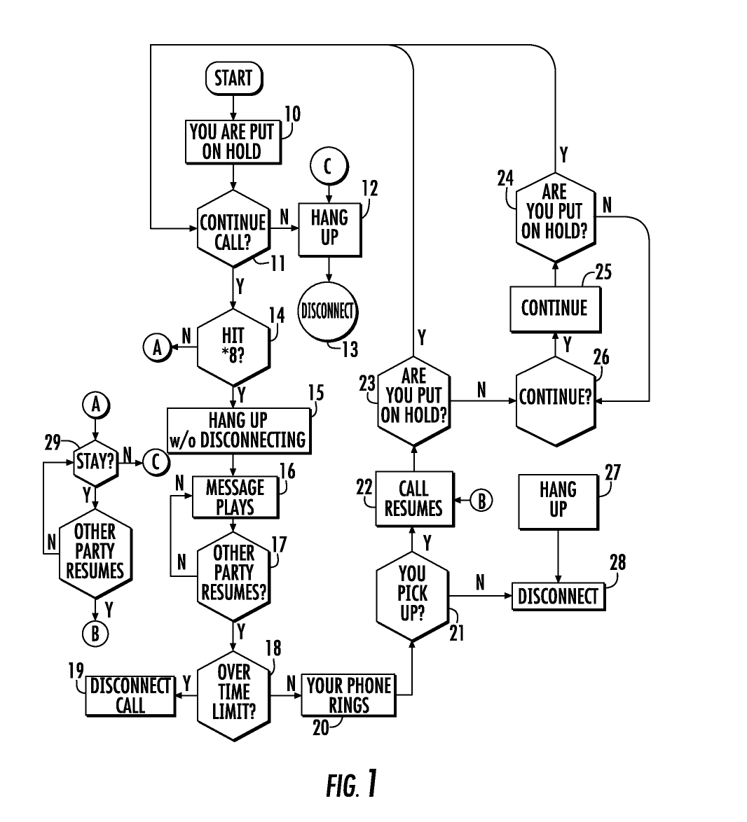

A first embodiment of the present invention, involving a switch at a telecommunications central office, is illustrated in FIGS. 1-4. FIG. 1 shows a schematic flow diagram of this first embodiment. The *8 call back phone feature of the present invention enables the user to avoid having to wait on the phone when put on hold by the other party to the call. It frees the user to move about and serves to alert the user when the other party takes them off hold and wants to resume the call. The *8 call back feature enables the user that has been placed on hold to hang up the phone without disconnecting the call.

With reference to FIG. 1, when the user is on a call and is placed on hold by the other party 10, the user has the choice of continuing the call 11. If the user chooses not to continue the call 12, he or she hangs up 12 and the call is disconnected 13. If instead the user chooses to continue the call 11, he or she hits the * and the 8 keys in succession on his or her phone 14, and then can hang up the phone without disconnecting the call 15. The other party then hears a recording that says something like “you have been placed on temporary hold, hit any key to resume this call” 16. Alternatively, instead of the message of 15, the other party can be made to hear a special dial tone. A time limit for being kept on hold can be preset by the user. If the other party resumes the call by hitting any key 17 and the preset time limit for being kept on hold is not exceeded 18, the phone of the user rings 20. The ring can be an ordinary ring as with a new call or a special ring to signify a call back. All of the user's phones can ring as with a new call or only the phone from which *8 was activated can be made to ring, at the user's option.

If the user answers the ringing phone 21, then the call resumes 22. If not answered 21 within the time limit, then the call goes to voicemail, if otherwise set up to do so or otherwise is disconnected 28. If the call resumes 22 and the user is again put on hold 23 (which can happen any number of times during a call), then as before the decision is made by the user 11 to continue the call 11. If so, the user decides whether to wait on hold or to hit *8 as at 14. If not, the user hangs up 12 to end the call. If so, the user waits on hold 29 until the other party resumes the call 17. Though not shown, hitting *1 can disconnect the call; and, hitting *5 can return to normal hold after activating *8.

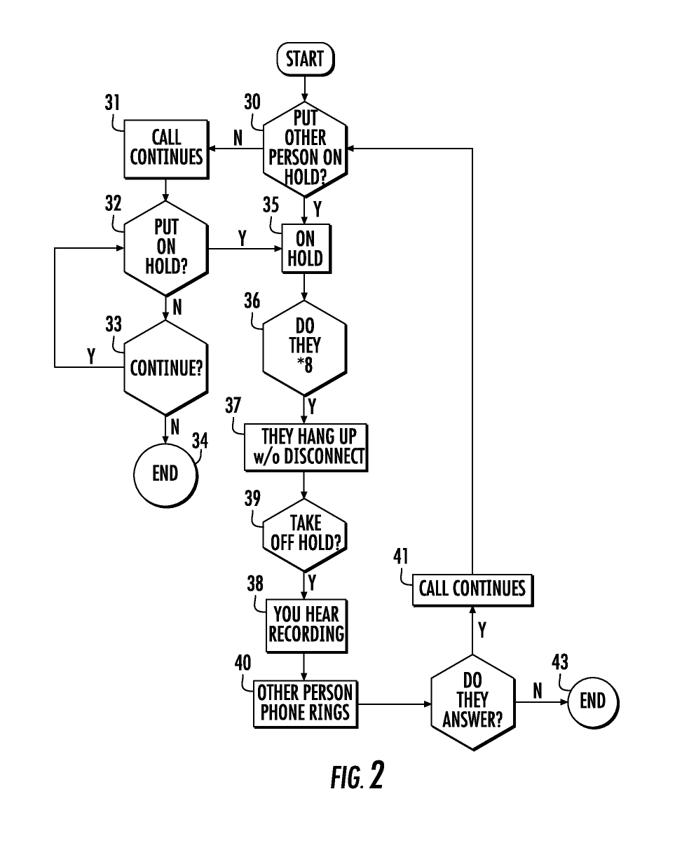

FIG. 2 describes the situation in this embodiment where the user puts the other person on a call on hold 30. If not, the call continues 31 or 33 unless the call is ended 34 by either party hanging up. When the other person is put on hold 35, they must decide whether to use the *8 feature 36. If they do not activate *8 such as at 36, they remain on hold 35 until taken off hold by the user. If the party on hold activates *8, they hang up the phone without disconnecting the call 37. The user (who placed the other party on hold) would not hear the recording “hit any key to resume the call” or the like or a special dial tone 38 until the call is taken off hold at their end. At 37 and 31, the called party could put this party on hold via *8 without this party using hold—in which case they would hear the recording right away.

If the user takes the “party on hold” off hold by hitting any key 39, then the other party's phone will ring 40. If they answer the ringing phone or phones 42, then the call resumes 41. If not answered 42, then the call goes to voicemail if available or ends by being otherwise disconnected 43 such as by a hang up.

If someone else picks up an extension phone at a location where a call has been placed on *8, the system can either allow that person to disconnect the call that has been placed on *8, by hitting the * key and then the 1 key in succession in order to free up the line. Alternatively, the system can be set up so that the call placed on *8 cannot be disconnected from any phone other than the one where it was activated or only by a special code known only by the person that activated the *8 feature. When the user of *8 or someone in his/her house picks up the phone after *8 has been activated, the following takes place: a recorded voice says “press *8 and hang up to reset clock and keep on hold callback activated, press *1 and hang up to disconnect, press *5 without hanging up to discontinue *8 feature and remain on hold.” This allows the user to change his/her mind about the *8 and go back to remaining on hold as was done before activating *8. Also *8 is no wait; *1 is I am done; and *5 is call is live.

Call waiting could be automatically deactivated by a call that has been placed on *8 or it could operate like normal call waiting so as to keep the call on hold on *8 status while the new call rings and is answered, until the user switches back to the *8 call. If a third call comes in while one is on *8 and the other is being received, it would go directly to voicemail, or if not available, it would keep ringing or provide a busy signal.

Options available as part of the present invention include: restarting the time limit for being on hold by hitting *8 a second or successive times; and/or having *8 work with call forwarding so that when a call is taken off hold, the resulting ring back will be directed to whatever phone number has been set for call forwarding so that the user can receive the *8 call back on a cell phone or other remote location.

One who puts another on hold does not need to press the hold key. At anytime in the conversation, either the caller or one called can activate *8. Usually, the phone will have to be hung up after *8 is activated so that it will ring because of the callback. However, the system could be set up so that it is not necessary to hang up after selecting *8.

If the phone system can detect that that someone was placed on hold or if there is silence for an extended period of time, an automatic recording will play offering the holder (the person placed on hold) the option of using *8. This provides another way for the phone company to offer the *8 service.

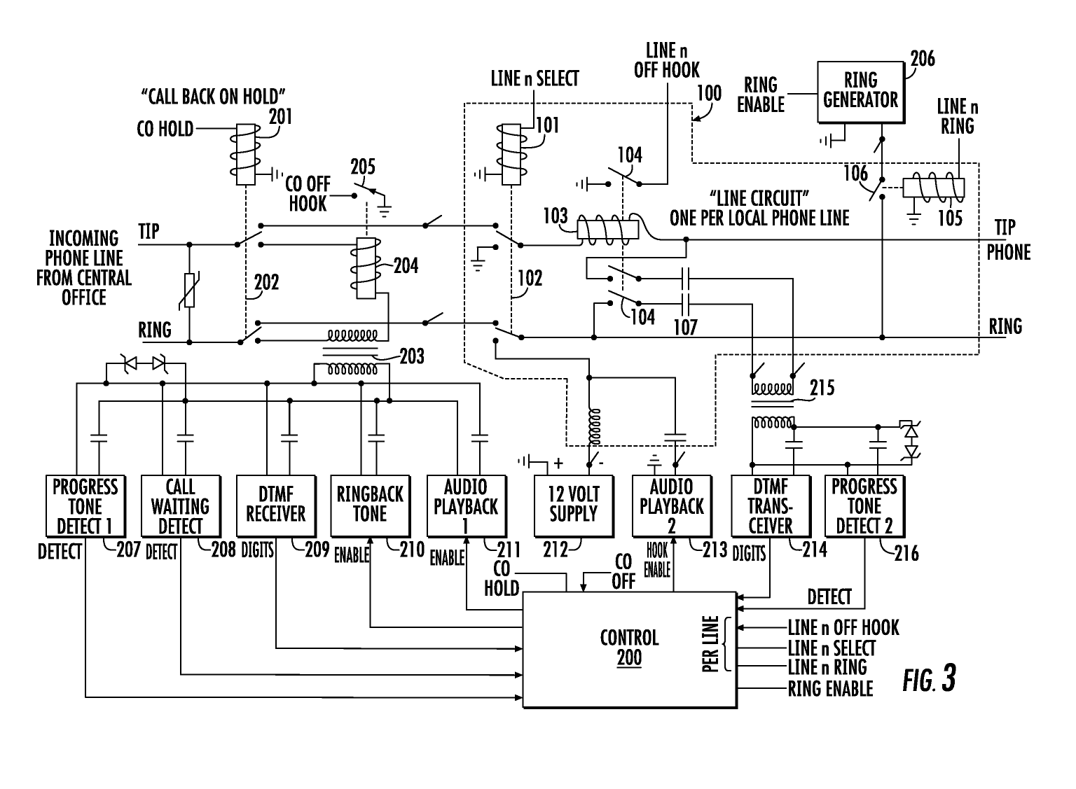

With respect to FIG. 3, the circuit consists of a common section, with components numbered 200-216, and a per-line section (100), with components numbered 101-107. The circuit may have just one line circuit, with multiple phones attached to the Phone side Tip and Ring terminals. However this will limit some of the multi-phone features of the invention. If multiple phones are to be connected, normally there would be a separate line circuit 100 per phone.

The circuit as shown makes use of several conventional relays, but that is for illustrative purposes only, and solid-state components may be substituted without any loss of functionality as long as they meet FCC Part 68 isolation requirements. For example Clare (www.clare.com) makes a Line Card Access Switch IC (CPC7591) which implements two Form-C contacts (relays 201 and 101 in the circuit and associated contact pairs 202 and 102). They also make a Multifunction Telecom Switch IC (TS 117) that can be used for line sensing (relays 204 and 103). Other companies make similar products. But for the purposes of discussion, it is easier to show the operation with conventional relays. Likewise, component values are not shown in the circuit as they are not critical to the discussion of the invention.

The hold circuit is shown as a 1:1 transformer 203. It would typically have a DC resistance of a couple hundred ohms and an AC impedance of 600 ohms to match the telephone line. Back-to-back Zener diodes are placed across the secondary of the hold transformer (203) to limit dangerous voltages reaching the audio components. Transient protection is also provided by a MOV across the Tip and Ring leads coming from the central office (CO).

Note in the normal state of the circuit (all relays off) there is a straight path from the CO Tip and Ring to each telephone's Tip and Ring leads via normally-closed contacts 202 and 102, with the only extra components in the line being the Line n Off-Hook relays 103 which senses which phone(s) are off-hook.

When a phone is taken off-hook, the appropriate Line n Off-Hook relay 103 will become engaged, putting a ground on the Line n Off-Hook lead via one of its normally-open contacts 104. Two additional normally-open contacts are also closed, connecting the capacitance-coupled transformer 215 which allows a dual-tone multi-frequency (DTMF) transceiver 214 to monitor the line for Touch-Tone digits. Normally only one line is connected to the DTMF transceiver at a time, to minimize the parallel capacitance placed on the line.

Several major conventional components of the system are show in block form, as their design and function are well known in the art. Ring Generator 206 generates 20 Hz ringing voltage 75 volts AC (one second on, two seconds off, designed to be distinctive from the central office cadence of two seconds on, four seconds off). There are many ringing circuits described on the Internet, such as using a 555 timer IC for the 20 Hz and a 120 v to 9 v transformer wired backwards to generate the required voltage. The cadence is controlled via the Control logic via the Ring Enable lead.

The Progress Tone Detectors (207 and 216) detect Dial tone (350+440 Hz in the US), Busy tone (480+620 Hz), and Howler (a.k.a. Receiver Off-Hook) tone (1400+2060+2450+2600 Hz). The lower tones (350 to 620 Hz band) can be detected via a single IC (CML CMX673). The Call Waiting Detector (208) detects the call waiting condition on the line and is also available as an IC (for example, the AGP8888 sold by Elan).

DMTF Receiver 209 detects the 12 different (0-9, * and #) Touch-Tones used in the US. Its function is available in several IC's, e.g. Mitel MT8870. DMTF Transceiver 216 both sends and receives the 12 different (0-9, * and #) Touch Tones used in the US. It is also available as a single IC. Ringback Tone Generator 210 is used to generate ringback tone (440+480 Hz), and can be implemented using a single 556 timer IC.

Audio Playback circuitry 211 and 213 are used to output short (10-20 seconds) audio messages. Winbond (www.winbond.com) provides several commercially available, one-chip solutions for accomplishing this function, such as their product No. ISD 1616B.

Current-limited 12 volt supply 212 is used to supply “talk battery” to the local phone(s) when they are disconnected from the CO line. Each line card includes a choke to isolate the audio and ringing voltage from the battery supply.

The following is a description of the “Callback on Hold” feature as applied to stand-alone end-user devices, telephone central offices (CO), Voice over Internet Protocol (VoIP) systems, including digital broadband VOIP modems, private branch exchanges (PBX), corded and cordless telephones, and cellular phone systems, which implement the “ON HOLD CALLBACK TELEPHONE FEATURE”.

When implementing the first embodiment of the present invention in conjunction with a Telephone Central Office, the Callback on Hold feature can be implemented on any stored-program control (SPC) central office telephone switch, which handle virtually all land-based phone lines in the United States. Most of these are all-digital exchanges, first deployed in the 1980's in which the analog voice signals are digitized at the incoming calling subscriber's line card, passed through a time-space-time (T-S-T) network, and converted back to analog at the called subscriber's line card. Examples of such exchanges are the No. 5 ESS, originally manufactured by Western Electric and now by Alcatel-Lucent; the DMS-100, originally manufactured by Northern Telecom, now Nortel; and the GTD-5 EAX, originally manufactured by GTE Automatic Electric and now also sold by Alcatel-Lucent.

Since the call processing functions of such a switch are entirely handled in software, the “Callback on Hold” feature can be implemented on any of these switches by just adding the feature to the call processing (CP) software—no additional hardware is required.

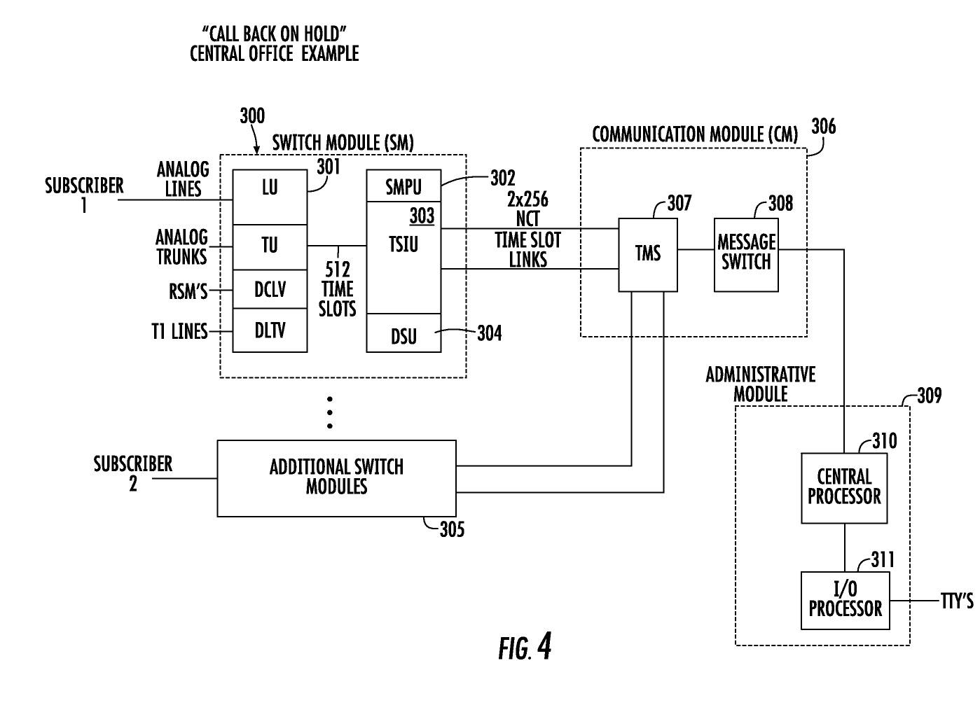

FIG. 4 is a block diagram of a typical No. 5 ESS, which will be used to illustrate the implementation of the “Callback on Hold” feature. There are a plurality of Switch Modules (SM) 300, which interface via Line Units (LU) 301 to analog subscriber lines; Trunk Units (TU), to analog trunks to other central offices; Digital Carrier Line Units (DCLU), to remote switch modules; and Digital Line Trunk Units (DLTU) to T1 lines. Each line or trunk is associated with one timeslot, and there are 512 timeslots switched within one SM.

Each SM contains Switch Module Processor Unit (SMPU) 302, a microprocessor locally handling many of the call processing functions for lines and trunks terminated on the SM. Time-Slot Interchange Unit (TSIU), 303 switches timeslots from the interface units to the Network Control and Timing (NCT) links for intermodule calls, and switches timeslots from one interface unit to another for intramodule calls. The Digital Service Unit (DSU) 304 provides high-usage service circuits, such as tone decoders and generators and recorded announcements.

Each SM is connected to Time Multiplexed Switch (TMS) 307 which performs space division switching between the SM's. Message Switch 308 provides for control messages between the Central Processor and the Communications Module.

Administrative Module 309 contains a redundant pair of Central Processors and main store 310, and a pair of I/O Processors 311 which communicate with terminals used to control the No. 5 ESS. In normal call operation, subscriber 1 is connected to subscriber 2 via the T-S-T network of the No. 5 ESS. (Note that the far end subscriber 2 may be either another line circuit, or a trunk circuit connecting to a subscriber in a remote switch.) For this example we will assume subscriber 1 and subscriber 2 are terminated in two different Switch Modules. Subscriber 1 is connected to one of the analog Line Units, block 301. His call is assigned a timeslot which is routed through the Time Slot Interchange Unit 303 to the Time Multiplex Switch block 307, and to the second Switch Module 305 where subscriber 2 is connected.

Because subscriber 1 has subscribed to the “Callback on Hold” feature, while he is connected a DTMF receiver contained in the Digital Service Unit 304 is also monitoring subscriber 1's line.

If the subscriber 1 is placed on hold by the far end party (subscriber 2), and subscriber 1 wishes to use the “Callback on Hold” feature, he hits a specific key sequence on his Touch-Tone pad, such as * 8. As the digits are received, they are passed to the call processing software from DTMF receiver in the DSU. (Note that this software may reside in the switch module or the main processor, depending on the software architecture of the switch. In the case of No. 5 ESS, call processing functions for a line or trunk are handled locally with the SM by the SMPU.)

If the call processing software determines that the correct sequence of keys has been pressed, then it puts the call on hold by routing subscriber 1's timeslot to a recording in the DSU. It also sends a message to the Central Processor to notify the other SM to connect subscriber 2 to a recording in the DSU associated with that SM, and also to a DMTF receiver to listen for Touch-Tones. Note at this point since both subscribers are connected locally to a recording, the space-division connection in the TMS between the two SM's can be torn down. Once the subscriber hangs up the phone he dialed from, subscriber 1's line circuit will detect this and report this fact to the call processing software.

While subscriber 1's line is on hold, an audio message (e.g. “Hit any key to resume”) is played via to the far end. If the far-end party subscriber 2 takes the call off hold at her end, hears the message and then presses a Touch-Tone key on her phone, the digit will be picked up by the DTMF receiver in the DSU in SM 305 and passed on to the call processing software. The call processing software will in turn disconnect the audio playback and instead connect the line to a ringback generator. Meanwhile it will instruct the Central Processor to tell subscriber 1's SM to ring his line. The ringing generator could be made to provide either a standard ring cadence of two seconds on, four seconds off, or a special ring such as one second on, two seconds off to indicate a callback.

If the subscriber answers the phone, subscriber 1's line circuit will indicate this to the call processing software. Once again a DTMF receiver in DSU 304 will be connected to listen for Touch-Tones. The call processing software will play a recorded message by connecting the line to a recording in the DSU, giving the subscriber the various options available (press * 5, * 1 or * 8). If the user chooses to drop the hold, the call processing software will send a message to the Central processor to connect the two subscribers back together via the TMS, and at this point the system is back to the original call state it was in before the call was placed on hold. The DTMF receiver in DSU 304 will still remain on the line in case subscriber 1 wishes to use the “Callback on Hold” feature again.

While subscriber's line is still on hold, if another call comes in and the subscriber has the call waiting feature enabled, the call processing software will ring subscriber 1's line (note this is different than normal call waiting operation). When the subscriber answers, the line will be connected to a recording in the DSU to announce that a second call is waiting. After pressing * 8 to be connected back to the call, the subscriber can then flash the switch hook to connect to the new call. If desired, a different ringing cadence could be used for a call waiting.

While a call is on hold, if the far end party subscriber 2 disconnects then the call processing software will simply drop the call, thus making the line available for another call.

If, while the “Call Back on Hold” feature is engaged, a subscriber picks up the phone and dials 911, the call processing software will receive the digits 911 via the DTMF receiver. It will immediately drop the call to subscriber 2, and process the 911 call as normal.

If, from a resource standpoint, it is considered too expensive to leave a DTMF receiver connected to subscriber 1's line all the time, then the system could be programmed to require a hook flash first. On seeing the hook flash, the SM would then connect a DTMF receiver to the line and provide a special dial tone or message via the DSU.

When subscriber 1 has the call on hold, an audio message is being sent to the far end subscriber 2, and a DTMF receiver is connected to the line to receive Touch-Tone digits from the far end. To avoid this, the system could be programmed to require a hook flash from subscriber 2 also. However this would only work if subscriber 2 is terminated on an SM line circuit controlled by the same administrative module, since hook flashes can not be propagated along trunk circuits. If subscriber 2 is connected to another stored-program exchange that implements the “Call Back on Hold” feature, then that system could monitor the line for a hook flash, collect the digits and send them back to the first exchange via Common Channel Signaling System 7 protocols. Note in this case (the two exchanges cooperating together to provide the “Call Back on Hold” feature), it would even be possible to drop the long distance voice circuit between the two exchanges during the hold period (which may stretch for several minutes), and reconnect it as needed when subscriber 1 answers the phone and elects to drop the hold.

When implementing the present invention in conjunction with Voice over Internet Protocol technology, there are several different “flavors” of VoIP service in common use today. The most common method is to use an analog telephone adapter (ATA). The ATA allows one to connect a standard phone to your computer or directly to your Internet connection. It provides dial tone when the handset is picked up to indicate an Internet connection is available, and rings the telephone set when an incoming call is received. Providers like Vonage typically bundle an ATA with their service. VoIP calls may be made between an ATA-connected phone, and any other type of phone, including the public switched telephone network (PSTN), cellular phones, and other VoIP phones.

The easiest way to add the Callback on Hold feature to an ATA-connected phone would be to use the end-user version of the device described earlier herein in between the analog phone and the ATA. The other way would be to include the feature within the ATA itself, since the device already has much of the circuitry required.

The second type of VoIP is to use Internet Protocol (IP) phones, which have an RJ-45 Ethernet connector instead of traditional RJ-11 telephone connector. They can connect directly to a router. Wi-Fi IP phones allow a subscriber to make VoIP calls using any Wi-Fi hot spot. As with ATA-connected phones, VoIP calls may be made between IP or Wi-Fi phones, and any other type of phone, including the PSTN, cellular phones, and other VoIP phones.

Obviously, it would not be possible to use the standard end-user version of the Callback on Hold feature with either of these types of phones. The only way to add the Callback on Hold feature would be to include the feature within the phone itself

The third type of VoIP is a direct computer connection using a headset and microphone; no phone is involved. For this discussion we are using that the user is still subscribing to a VoIP service such as Skype or Vonage and using their “softphone” interfaces, which have a screen which looks like a traditional telephone.

Since this solution is entirely software-driven from within the PC, it would be possible to add the Callback on Hold feature by modifying the Skype, Vonage or other softphone software being used. Note that in the case of VoIP, whichever type of phone connection is being used (ATA, IP or Wi-Fi phone, or computer “softphone”), if the call is being made from one VoIP endpoint to another, there is no “central switch” which is monitoring the call, since packets going from one endpoint to another may take different paths. (In the case of a VoIP phone call to a phone on the PSTN, there would be a gateway switch, and the feature could be implemented as described earlier for the central office.) But the implementation of the Callback on Hold feature for VoIP to VoIP calls in general requires modifications to the endpoint devices, whether hardware, software or a combination of the two.

For Private Branch Exchange implementations, unlike manufacturers of central offices switches, which are relatively few in number, there are hundreds of manufacturers of digital PBX's, too many to list here. Although older analog PBX's are still in use, in this document we are assuming a digital PBX using stored-program control, as we did in the central office case. (In the case of older, analog PBX's it would generally be possible so add the standard end-user version of the Callback on Hold feature to a PBX line.).

PBXs operate as a connection between a business or other organization and the PSTN. Because they can connect telephones, fax machines, modems, and more, the general term “extension” is used to refer to any end point on the switch. The PBX handles calls between these extensions as well as connections to the PSTN via trunk lines connecting the PBX to a central office.

One of the selling features of PBX's is the ability to provide features not available from the CO; so the Callback on Hold feature could be added to a PBX's repertoire of features even if the CO doesn't support it. In addition, PBX's often use proprietary digital phones unique to the particular vendor, so it may not even be possible to add the standard end-user version of the Callback on Hold feature to a PBX extension. In any case, it would be much more efficient to add the feature to the entire switch via a software upgrade and make it available to all users.

Operationally, the implementation of the Callback on Hold feature in a PBX would be essentially the same as described earlier for the central office, since from a call processing point of view they are very similar. One variation with a PBX that has proprietary digital phones with programmable feature keys, would be to have the Callback on Hold feature assigned to a key, so instead of dialing * 8 the user would just press a key.

When implementing the present invention in conjunction with cellular telephone technology, cellular phones in the United States use one of three air technologies known as Code Division Multiple Access (CDMA), Time Division Multiple Access (TDMA), or Global System for Mobile communications (GSM, a variation of TDMA). All of Europe and most of the rest of the world uses GSM. Personal Communications Service (PCS) is a variation of digital phone services on a higher frequency band (1900 MHz), using either CMDA or GSM.

The equivalent to the central office in the cellular telephone network is the Mobile Telephone Switching Office (MTSO), also referred to as the Mobile Switching Center (MSC). This switch can be a normal landline switch like a 5ESS or a dedicated one like one from Motorola. Each carrier in a metropolitan area has one MTSO, which controls all of the carrier's base stations (cell towers) in the area. Depending on the type of system, such as GSM or PCS, there may be an intermediate level processor called the Base Station Controller (BSC) under the MTSO/MSC that controls several base stations, including handoff of a cell phone from one cell to another but its presence doesn't affect this discussion.

The MTSO handles all connections between the cellular phone customers and the normal land-based stations in the area, as well as connecting to the Internet for VoIP service. Since the Callback on Hold feature is related just to call processing, it is independent of the type of cellular system and would be implemented as an addition to the call processing software in the MTSO or MSC.

Operationally, the implementation of the Callback on Hold feature in a cellular system would again be essentially the same as described earlier for the central office. The main difference is in the setup of the call, since there is no dial tone; rather subscriber 1 keys in the phone number and presses Talk. The digits are then sent from the base station to the MTSO.

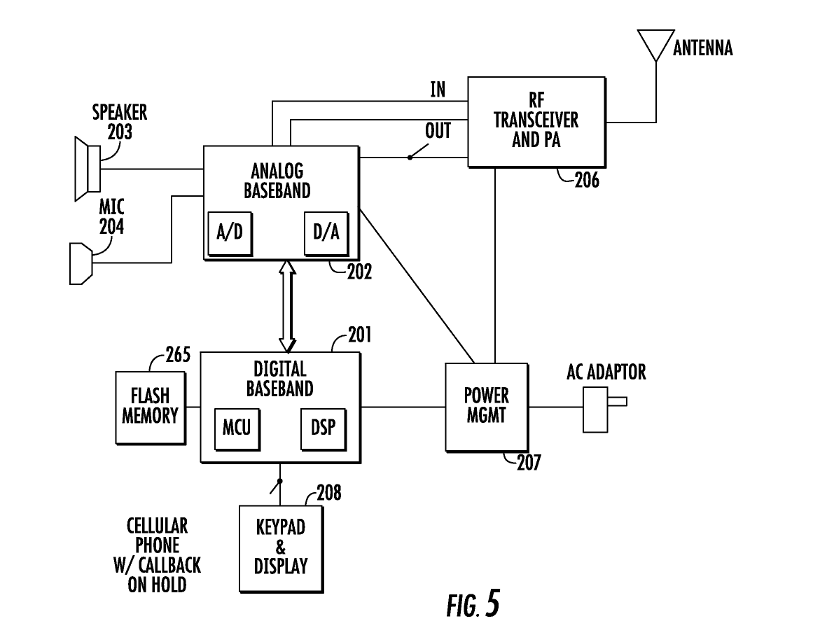

FIGS. 5-12 illustrate a second embodiment of the invention, capable of performing “on-hold call back” without any required cooperation from a central office switch, implemented in a variety of consumer electronic devices, including cellular telephones, electronic land-line telephones, stand-alone answering machines, answering machines with integrated telephone sets, and cordless telephone answering systems.

Referring to FIG. 5, the second embodiment of the present invention is implemented using, in part, embedded microprocessor-based software or firmware additions to a conventional cellular telephone. As shown in FIG. 5, the major components of a standard cellular telephone include a Digital Baseband 201 which includes the microcontroller (MCU) and Digital Signal Processor (DSP); Analog Baseband 202 which includes Analog to Digital (A/D) and Digital to Analog (D/A) converters; Speaker 203; Handset microphone 204; Flash memory 205; RF Transceiver and Power Amplifier (PA) 206 connected to the antenna; Power management circuitry 207 including a battery which can be connected to a AC adapter for charging; and keypad and display unit 208.

Various DTMF tones are detected and generated, and ring tones and audio messages are generated using the Digital Signal Processor (DSP) portion of Digital Baseband 201. Included within the DSP is software to implement the following functionality: The DMTF Transceiver module both sends and receives the 12 different (0-9, * and #) Touch-Tones used in the US. A Ringback Tone Generator module is used to generate ringback tone (440+480 Hz). An Audio Playback module is used to output short (10-20 seconds) audio messages which are stored in Flash Memory 218. The audio tones from the DSP are converted to analog using the digital to analog converters (D/A) of Analog Baseband 202. Audio tones are input to the DSP via the analog to digital converters of Analog Baseband 202.

In operation, if the subscriber is placed on hold by the far end party, and they wish to use the “Callback on Hold” feature, they would either press a dedicated key on the cell phone which activates Callback on Hold, or (if no special key was dedicated to this function) activate a menu on the display and select Callback on Hold. If the MCU determines that the Callback on Hold feature has been selected, then it puts the call on hold by disconnecting the talk path between Analog Baseband 202 and handset speaker 203 and microphone 204, but leaving the call connected to the far end via the Mobile Telephone Switching Office (MTSO).

While the MTSO line is on hold, an audio message (e.g. “Hit any key to resume”) is played via the Audio Playback module in the DSP and A/D converter to the far end. Two brief DTMF tone pairs would also be sent at the beginning of each of the announcements via a DTMF generator in the DSP.

There are actually sixteen DTMF (dual-tone multi-frequency) tone pairs defined for the US telephone network, not just the twelve that appear on virtually all telephone sets (0-9, * and #). The four extra tone pairs are called ‘A’, ‘B’, ‘C’, and ‘D’, and have been used mostly for military applications. However most DTMF transmitter and receiver integrated circuits can both generate and receive the extra frequency pairs.
Tone pair ‘A’ 697 Hz and 1633 Hz
Tone pair ‘B’ 770 Hz and 1633 Hz
Tone pair ‘C’ 852 Hz and 1633 Hz
Tone pair ‘D’ 941 Hz and 1633 Hz

The two brief DTMF tone pairs (e.g. ‘A’ and ‘D’) separated by 100 ms would cause the far end to light a lamp or LED on their telephone set to indicate the call has been placed on Callback Hold.

If the far-end party takes the call off hold at their end, hears the message and then presses a Touch-Tone key on their phone, the digit will be picked up by the DTMF Receiver module in the DSP. The MCU will in turn disable the audio playback and send ringback tone via the Ringback Tone Generator module in the DSP to the far end while it is ringing the local phone through the speaker.

If the subscriber answers the phone, the MCU will play a recorded message via Audio Playback module in the DSP, giving the subscriber various options available. If the user chooses to drop the hold, the MCU will reconnect the talk path from the handset speaker and microphone back to the call.

While the line is still on hold, if another call comes in and the subscriber has the call waiting feature enabled, then the software will detect the incoming call waiting and the MCU will ring the handset via the speaker. When the subscriber answers, the Display will indicate that a second call is waiting. The subscriber can then choose to connect to the new call. If desired, a different ringing cadence could be used for a call waiting.

While a call is on hold, if the far end party disconnects then the far end Central Office (CO) will momentarily open the loop for 250-500 ms which is known as the Calling Party Control (CPC) signal. This will be forwarded as a disconnect signal via the MTSO to the phone and the MCU will drop the call.

If, while the “Call Back on Hold” feature is engaged, a subscriber dials 911, the MCU will receive the digits 911. It will then drop the hold on the original call, and initiate a new call. Once the new call has been initiated, the MCU will re-send the digits 911 on to the MTSO.

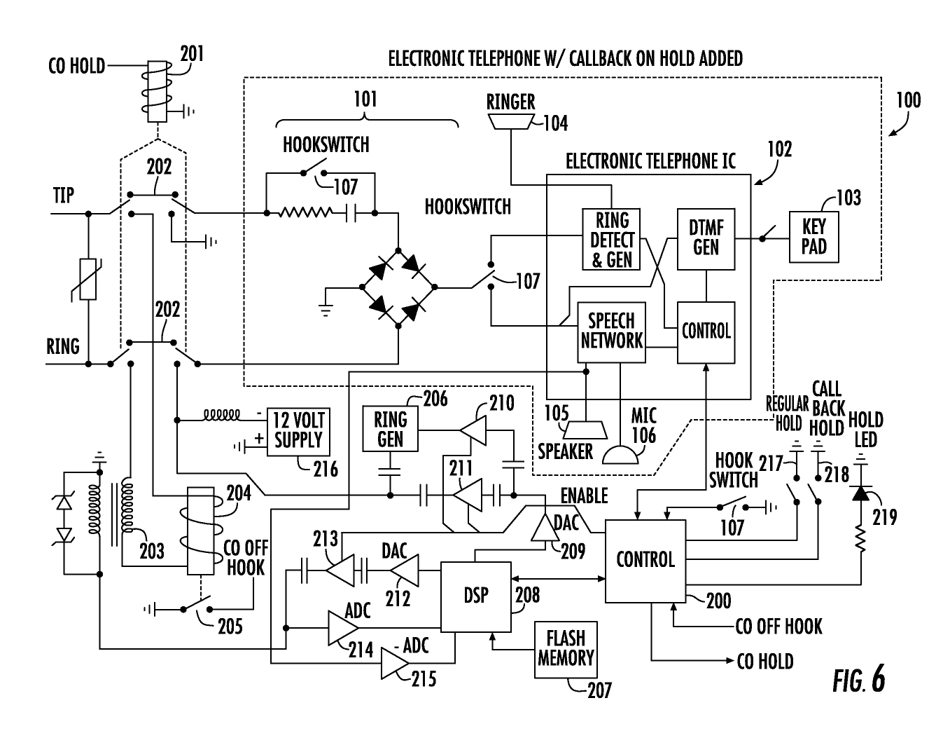

Referring to FIG. 6, the second embodiment of the present invention is shown implemented in addition to the circuitry 100 of a conventional, stand-alone electronic telephone set, comprising line interface 101; a single integrated circuit (IC) 102 containing most of the circuitry for the telephone set (including the speech network, DTMF generator, ring detect and generator circuits, and control logic); digit keypad 103 with buttons 0-9, * and #; electronic ringer 104; handset speaker 105; handset microphone 106; and hookswitch 107. It is presumed this existing telephone set circuitry does not have circuitry to place the line on hold.

Diode bridge (part of line interface 101) insures that a positive voltage is always presented to the input of the IC regardless of how the telephone set is connected to the Tip and Ring POTS wires. When hookswitch 107 is in its normal (off) position, the line is fed into the ring detection unit of IC 102. When ringing current is detected on the line, the ring detector and generator circuit of IC 102 activates electronic ringer 104. When the subscriber picks up the handset, the shunting resistor and capacitor on in the line interface 101 are shorted out, and the line is connected to the speech network and DTMF generator circuits of IC 102.

The additional circuitry for the Callback on Hold feature comprises is identified by reference numerals 200-219, shown outside dotted line 100. It is assumed this circuitry will be powered off of an AC adapter, not shown. By implementing the Callback on Hold feature separate from the rest of the telephone set 100, the telephone set may work normally even if an AC power outage occurs, as telephone set 100 will still be powered by the telephone line.

Control 200 is typically implemented using a conventional microcontroller. CO (Central Office) Hold Relay 201 operates contacts 202. When placed on hold, the line is fed through 600 ohm 1:1 transformer 203 and line relay 204 operating CO Off Hook contact 205.

Various call progress, DTMF and ring tones are detected and generated using Digital Signal Processor (DSP) 208. Included within the DSP is software to implement the following functionality: a Progress Tone Detector module detects Dial tone (350+440 Hz in the US), busy tone (480+620 Hz), and Howler (a.k.a. Receiver Off-Hook) tone (1400+2060+2450+2600 Hz). A Call Waiting Detector detects the call waiting condition on the line. The DMTF Transceiver module both sends and receives the 12 different (0-9, * and #) Touch-Tones used in the US. A Ringback Tone Generator module is used to generate ringback tone (440+480 Hz). A Ringing Tone Generator module is used to generate ringing tone (20 Hz). An Audio Playback module is used to output short (10-20 seconds) audio messages which are stored in the Flash Memory 207.

The audio tones from the DSP are converted to analog using the digital to analog converters (DACs) 209 and 212. The outputs of the DACs are fed into various amplifiers 210, 211 and 213. Audio tones are input to the DSP via analog to digital converters (ADCs) 214 and 215.

In normal call operation, if the subscriber is placed on hold by the far end party, and they wish to use the “Callback on Hold” feature, they hit a dedicated button, namely Callback Hold button 218. When the Control logic determines that the Callback Hold button has been pressed, it puts the call on hold by operating CO Hold relay 201, which disconnects the talk path between to the remainder of the telephone circuit 100, and connects the CO line instead to 1:1 transformer 203 and CO Off Hook relay 204. Meanwhile, the telephone circuitry in unit 101 is connected to a local loop powered by 12 volt supply 216. The Control logic will also light the Hold LED 219 in a distinct cadence to indicate the call has been placed on Callback Hold.

While the CO line is on hold, an audio message (e.g. “Hit any key to resume”) is played via the Audio Playback module in DSP 208 via DAC 212 and amplifier 213 to the far end. Two brief DTMF tone pairs would also be sent at the beginning of each of the announcements via a DTMF generator in the DSP.

If the far-end party takes the call off hold at their end, hears the message and presses a Touch-Tone key on their phone, the digit will fed into the DSP via ADC 214 and be detected up by the DTMF Receiver module in the DSP. The Control logic will in turn disable the audio playback and send ringback tone via the Ringback Tone Generator module in the DSP to the far end while it is ringing the local phone via second DAC 210 and Ring Generator 206.

Ring Generator 206 can be made to provide either a standard ring cadence of two seconds on, four seconds off, or a special ring of one second on, two seconds off to indicate a callback, since the timing is controlled by Control logic 200.

If the subscriber answers the phone, the Control logic in the base unit will play a recorded message via the Audio Playback in the DSP using DAC 209 and amplifier 211, giving the subscriber the various options available (press * 5, * 1 or * 8). Digits are received from the link between the control unit inside electronic telephone IC 102 and Control circuitry 200. If the user chooses to drop the hold, the Control logic will reconnect the talk path from the handset back to the CO line by dropping the CO Hold Relay.

While the line is still on hold, if another call comes in and the subscriber has the call waiting feature enabled, then the Call Waiting Detector module in the DSP will detect the incoming call waiting and the Control logic will ring the handset. When the subscriber answers, the Audio Playback in the DSP using DAC 209 and amplifier 211 will announce that a second call is waiting. After pressing a DTMF key to be connected back to the CO line, the subscriber can then flash the switch hook to connect to the new call. If desired, a different ringing cadence could be used for a call waiting.

While a call is on hold, if the far end party disconnects then the CO will momentarily open the loop for 250-500 ms which is known as the Calling Party Control (CPC) signal. This will be detected by the dropping of CO Off Hook relay 204. If the central office does not provide a CPC signal, then it will send dial tone usually followed by Howler (a.k.a. Receiver Off-Hook) tone. This will be detected by the Progress Tone Detector module in the DSP, which will cause the Control logic to again drop the CO line.

If, while the “Call Back on Hold” feature is engaged, a subscriber picks up the handset and dials 911, the Control logic will receive the digits 911 via the path between the control logic in telephone set IC 102 and Control unit 200. It will then drop the CO hold. Once dial tone is detected by the Progress Tone Detect circuit in the DSP via ADC 215 connected to the speaker output of telephone IC 102, the Control logic will re-send the tones for digits 911 on to the CO via the DTMF generator in telephone IC 102.

This circuitry also allows for the subscriber to put the other end on regular hold, by pressing key 217. In this case, Control logic 200 would operate the CO Hold relay, holding the line allowing the subscriber to replace the handset. The Control logic would also light Hold LED 219 in a distinctive pattern.

While the call is on regular hold, if the other end also has the callback on hold feature and activates it, then the far end will start sending audio announcements over the line preceded by two distinct tone pairs, ‘A’ and ‘D’ as described above. This condition will be detected by DSP 208 connected to ADC 214 and transformer 203, causing the Control logic to change the cadence of the Hold LED to indicate the far end has placed the call on Callback Hold (“Hold on Hold”). When the subscriber picks up the phone and presses the Hold key again to release the hold, the Control logic will drop the CO Hold and the subscriber will hear the voice announcement from the far end to press any Touch-Tone key to continue. When they do so, the Control logic 200 will receive the digits via the path between it and the control logic in telephone set IC 102, and extinguish the Hold on Hold LED indication.

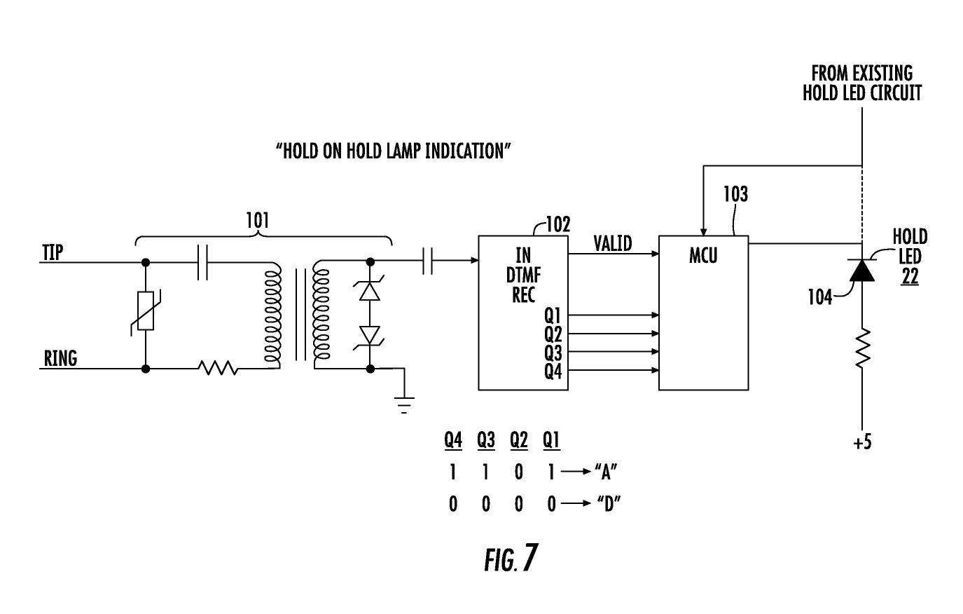

The circuitry implementing the Hold on Hold lamp operation is shown in detail in FIG. 7. The circuitry as shown assumes the invention is implemented as a stand-alone circuit independent of a telephone set, as it includes circuitry 101 needed to interface to the telephone line. The line interface consists of a varistor, to block high-voltage spikes on the telephone line; a 1:1 600 ohm line transformer, coupled via a capacitor to the telephone line so as not to draw any DC current so the line is not picked up. On the other side of the transformer is a pair of Zener diodes to limit the voltage levels. If this invention was implemented inside an existing telephone set, circuitry 101 could be eliminated, and the audio signals picked up from the existing speech network.

Whether from the line transformer or an existing speech network within a telephone set, the audio is passed through another capacitor to the input of DTMF receiver IC 102. For the purposes of this discussion, it is assumed that DTMF receiver IC 102 generates unique signals for each of the 16 DTMF tone pairs on output leads Q4 through Q1, and in particular,

| | Q4 | Q3 | Q2 | Q1 |
|---|---|---|---|---|
| Tone pair ‘A’ | 1 | 1 | 0 | 1 |
| Tone pair ‘B’ | 1 | 1 | 1 | 0 |
| Tone pair ‘C’ | 1 | 1 | 1 | 1 |
| Tone pair ‘D’ | 0 | 0 | 0 | 0 |

The DTMF receiver also has a “VALID” signal indicating a valid tone pair has been detected and available on the Q4 through Q1 outputs. All of the signals are fed into microcontroller (MCU) 103. The output of the MCU drives Hold lamp 104 (shown as an LED in this case, although other forms of illumination may alternatively be used). If the circuitry is contained within an existing telephone set which already has a Hold lamp or LED, then the line from the existing lamp can be broken (as shown via the dotted line proximate LED 104) and fed into the MCU. In that case, if a call is placed on regular hold, the MCU can repeat the lamp indication on the LED. Moreover, instead of having a separate MCU 103, the functions of MCU 103 described below could instead be integrated into the main control logic of the telephone set, such as a single microcontroller governing the overall operation of the telephone set.

In operation, a subscriber at the near end (calling end) calls for example a business at the far end (called end). The business subscriber places the call on hold (this may be either due to a person actually placing the call on hold using a hold key, or a call routing system that has queued the call before it is made available to one of several operators). The calling subscriber, which has the “Callback on Hold” feature on their telephone, places the call on Callback Hold and hangs up their telephone.

During the period when a call is placed on “Callback Hold” by the calling party, the circuitry at the calling end sends a repeat voice announcement back to the called end, advising the subscriber to hit any key on their telephone set to resume the call. In this invention, two brief DTMF tone pairs (e.g. ‘A’ and ‘D’) would also be sent at the beginning of each of the announcements.

The audio from the call is fed into DTMF receiver 102, either from line interface 101 or the speech network of the telephone. When either of the tone pairs, ‘A’ or ‘D’ is received, the DTMF receiver will assert the “VALID” line along with the appropriate output lines Q4 through Q1—1101 for ‘A’ and 0000 for ‘D’. The MCU, on detecting the two tone pairs ‘A’ and ‘D’ in sequence with a predetermined gap in between them (e.g. 100 ms), will light Hold LED 104 with a distinct pattern that is different from the normal Hold indication, to indicate the call is on “Callback Hold”. When the called party picks the line back up, hears the announcement, and presses any DTMF key to continue (which signals the calling end to ring the phone), DTMF receiver 102 also picks up this tone pair and sends it to the MCU. This causes the MCU to extinguish the Callback on Hold LED.

If the calling party decides to abandon the Callback on Hold while the call is still on hold by the called end (by the calling subscriber picking up their telephone and pressing a specific key sequence), then the voice announcements will stop along with the special tone pairs. After a delay longer than the longest voice announcement expected, e.g. 15 seconds, the MCU will extinguish the Callback on Hold LED. (If the “Hold on Hold Lamp Indication” feature was fully integrated into a telephone set, then the control logic could extinguish the light as soon as it detected the line had been dropped.)

If the call was placed on hold at the called end by a call routing system, then there will be LED to light since the call has not been routed to a telephone set yet. When the call is taken off hold and routed to a telephone set which has the Hold on Hold lamp indication circuit, then Callback on Hold indication will be lit at the beginning of the next voice announcement.

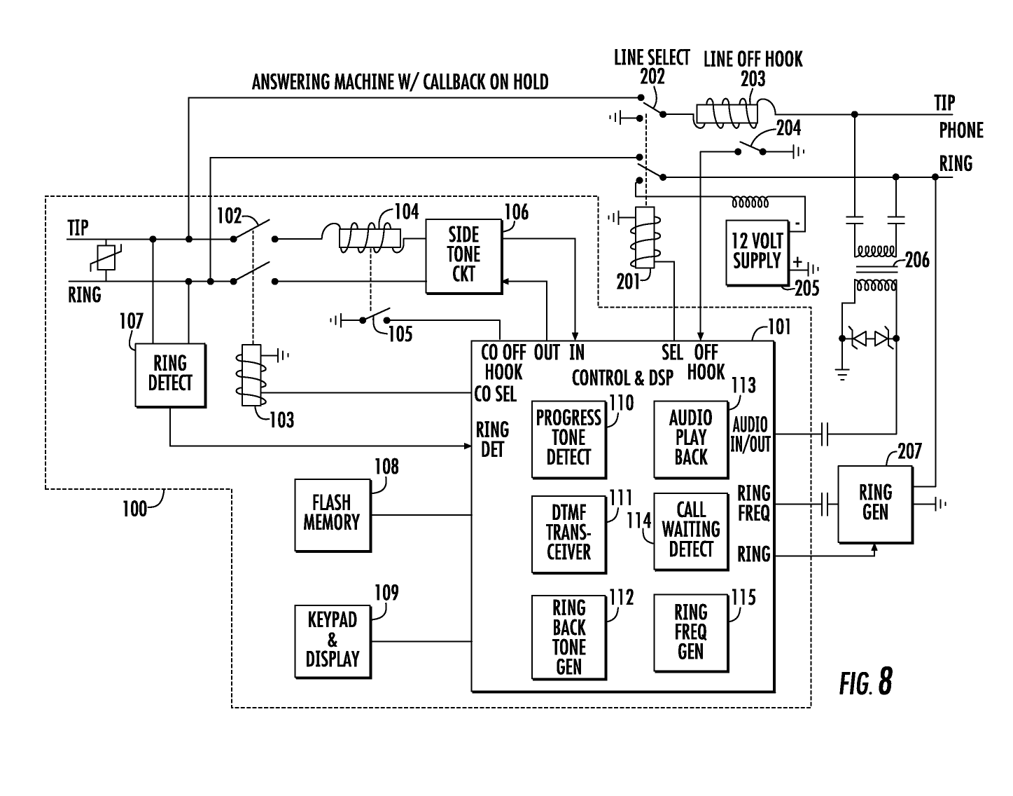

The circuitry for implementing the second embodiment of the present invention in the environment of a typical standalone electronic answering machine is shown in FIG. 8, with conventional answering machine circuitry identified within the dotted line of element 100. The additional circuitry for implementing the Callback on Hold feature of the present invention comprise components 201-207. Certain of the additional functionality for the Callback on Hold feature is implemented as software, or microprocessor/microcontroller firmware, inside Control & DSP 101 of the answering machine.

Conventional standalone electronic answering machine 100 is shown in FIG. 8 as comprising Control & Digital Signal Processor (DSP) 101; Ringing Detect circuitry 107; Central Office (CO) Line Select relay 103 and contacts 102; CO Line Off-Hook relay 105 and contact 104; Side-tone circuit 106 separating the audio path into transmit/receive; Flash Memory 108 storing outgoing and incoming audio messages; and Keypad and Display unit 109.

Control section 101 for a typical answering machine typically employs either a Digital Signal Processor (DSP) or a separate integrated circuit (such as the MT8870 product sold by Mitel) for detecting Dual-Tone Multi-Frequency (DTMF) Touch-Tones used in the United States. For the purposes of illustration, we will assume a DSP is employed to perform this function, as its capabilities can be expanded (via software) to handle the following functions: Progress Tone Detector 110 detects Dial tone (350+440 Hz in the US), Busy tone (480+620 Hz), and Howler (a.k.a. Receiver Off-Hook) tone (1400+2060+2450+2600 Hz). Call Waiting Detector 114 detects the call waiting condition on the line. DMTF Transceiver 111 both sends and receives the 12 different (0-9, * and #) Touch-Tones used in the US. Ringback Tone Generator 112 is used to generate ringback tone (440+480 Hz). Ringing Tone Generator 115 module is used to generate ringing tone (20 Hz). Audio Playback unit 113 is used to output short (10-20 seconds) audio messages which are stored in Flash Memory 106.

Audio signals fed into the DSP would are passed through Analog to Digital Converters (ADCs) connected to the In and Audio In/Out leads of Control & DSP unit 101. Outgoing audio from the DSP is be passed through Digital to Analog Converters (DACs) and amplifiers connected to the Out, Audio In/Out, and Ring Freq leads of Control & DSP unit 101. For simplicity, the ADCs, DACs and amplifiers are not shown in FIG. 8.

Additional circuitry required for implementing this embodiment of the callback on hold invention include Line Select relay 201 and contacts 202 for switching the telephone connected to the answering machine from the CO line to a local loop powered by a 12 volt supply 205; Line Off-Hook relay 203 and contact 204 for sensing when the attached telephone is off-hook; capacitor-coupled 1:1 transformer 206 which allows audio signals to pass back and forth between the attached telephone set and the DSP; and a Ring Generator 207 which generates 20 Hz 75 v AC ringing voltage to ring the attached telephone set.

While the circuit as shown makes use of several conventional relays, solid-state components may be substituted without any loss of functionality so long as they meet FCC Part 68 isolation requirements.

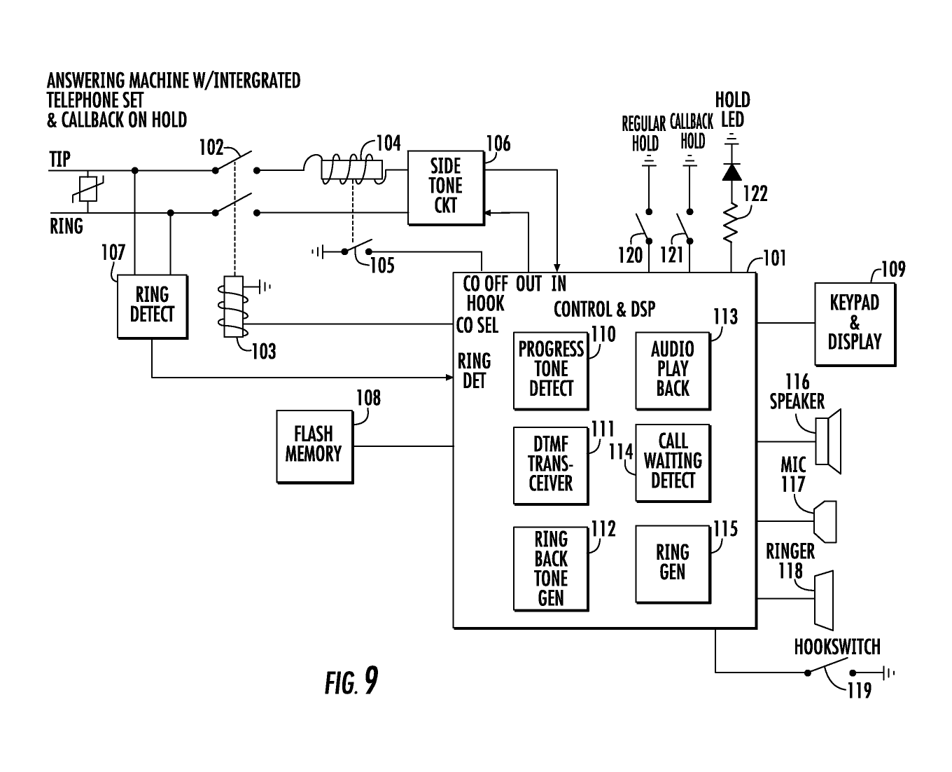

The circuitry for implementing the second embodiment of the present invention in the environment of a combination answering machine and integrated telephone set is shown in FIG. 9. Much of the additional functionality for the Callback on Hold feature is implemented as software or firmware stored within read-only memory or flash memory of Control & DSP 101 of the combination answering machine and integrated telephone set.

Referring to FIG. 9. an electronic answering machine with integrated telephone set typically comprises the following components: Control & Digital Signal Processor 101; Ringing Detect circuitry 107; Central Office (CO) Line Select relay 103 and contacts 102; CO Line Off-Hook relay 105 and contact 104; Side-tone circuit 106; Flash Memory 108 for storing outgoing and incoming messages; Keypad and Display 109; Handset Speaker 116; Handset Microphone 117; Electronic Ringer 118; and Hookswitch 119.

Control section 101 includes the following functionality: Progress Tone Detector 110; Call Waiting Detector 114; DMTF Transceiver 111; Ringback Tone Generator 112; Ringing Generator 115 controlling electronic ringer 118; and Audio Playback Unit 113 is used to output audio messages which stored in Flash Memory 106.

Audio signals fed into the DSP or microcontroller portion of Control section 101 are passed through an Analog to Digital Converter (ADC) connected to the In lead of the Control & DSP 101. Outgoing audio from the DSP is passed through a Digital to Analog Converters (DAC) and amplifiers connected to the Out and Handset Speaker leads of the Control & DSP 101. The only additional circuitry necessary for the Callback on Hold feature of the second embodiment of the present invention is Callback on Hold button 121 and Hold LED 122 (if not already part of the device). For purposes of illustration, a separate button 120 for a regular line hold function is also shown. Operation of the callback on hold function of the present invention is similar to that described above with respect to, for example, the embodiment of FIG. 6, directed to a conventional electronic telephone with callback on hold added.

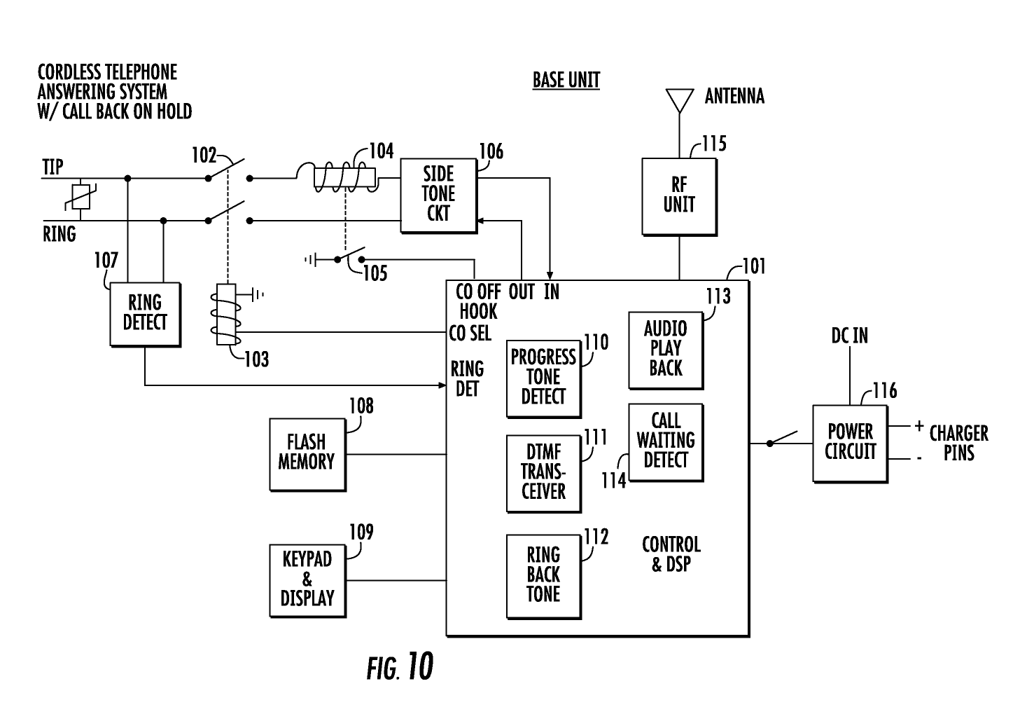

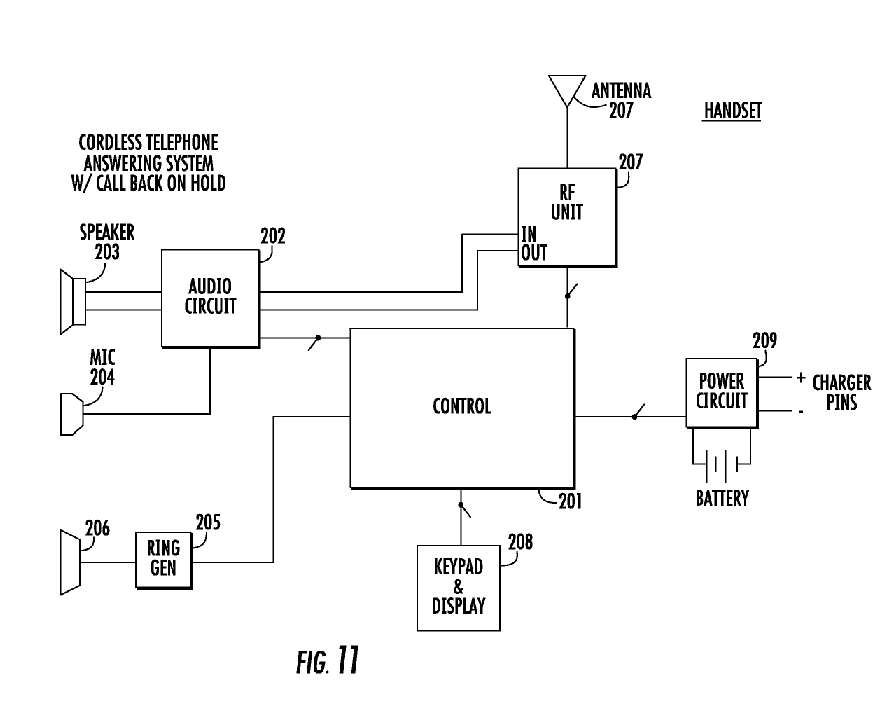

The circuitry for implementing the second embodiment of the present invention in conjunction with a cordless telephone system is shown in FIGS. 10-11. For purposes of illustration, FIGS. 10-11 depict the cordless telephone system in combination with an integrated telephone answering system. However, the second embodiment of the second invention can alternatively be implemented in a cordless telephone system that does not include an integral answering system.

The cordless telephone and answering system comprises a base unit, shown in FIG. 10 as including components 101-116, and a handset unit, shown in FIG. 11 as including components 201-209. Multiple handset units depicted in FIG. 11 may optionally be included in this embodiment

Referring to FIG. 10, the major components of the base unit include Control & Digital Signal Processor (DSP) unit 101; Ringing Detect circuitry 107 Central Office (CO) Line Select relay 103 and contacts 102; CO Line Off-Hook relay 105 and contact 104; Side-tone circuit 106; Flash Memory 108 storing outgoing and incoming messages; Keypad and Display 109; RF Unit and Antenna 115; and Power Management and Charging circuit 116. The circuitry for performing the Callback on Hold function of the present invention are implemented by components having reference numerals 110 through 114, comprising subsystems within Control logic 101, including Progress Tone Detector 110; Call Waiting Detector 114; DMTF Transceiver 111; Ringback Tone Generator 112; and Audio Playback unit 113, outputting audio messages stored in the Flash Memory 106.

Referring to FIG. 11, the major components of the handset unit, components 201 through 209, are already present in a typical cordless handset, and no additional circuitry is required to implement the Callback on Hold function of the present invention, apart from an optional, dedicated button to initiate the Callback on Hold feature, and an optional, dedicated LED or other display to indicate the line is being held. The handset included Control section 201, typically comprising a microprocessor, microcontroller, or digital signal processor; Audio circuit 202; Handset Speaker 203; Handset Microphone 204; Ring Generator 205 and Ringer 206; RF Unit and associated Antenna 207; Keypad and Display unit 208; and Power Management and Charging circuit 209.

Keypad and Display units 109 (for the base unit) and 208 (for the handset) include additional dedicated keys or buttons for commanding the callback on hold function. Alternatively, a keypad combination can be recognized by the associated control circuitry as commanding the callback on hold function. Moreover, Keypad and Display units 109 (for the base unit) and 208 (for the handset) include dedicated lights or lamps indicating whether or not the callback on hold function is presently in operation. Alternatively, a portion of an LCD or other graphical display associated with the keypad and display units may be employed to provide this indication. Operation of the callback on hold function of the present invention is similar to that described above with respect to, for example, the embodiment of FIG. 6, directed to a conventional electronic telephone with callback on hold added.

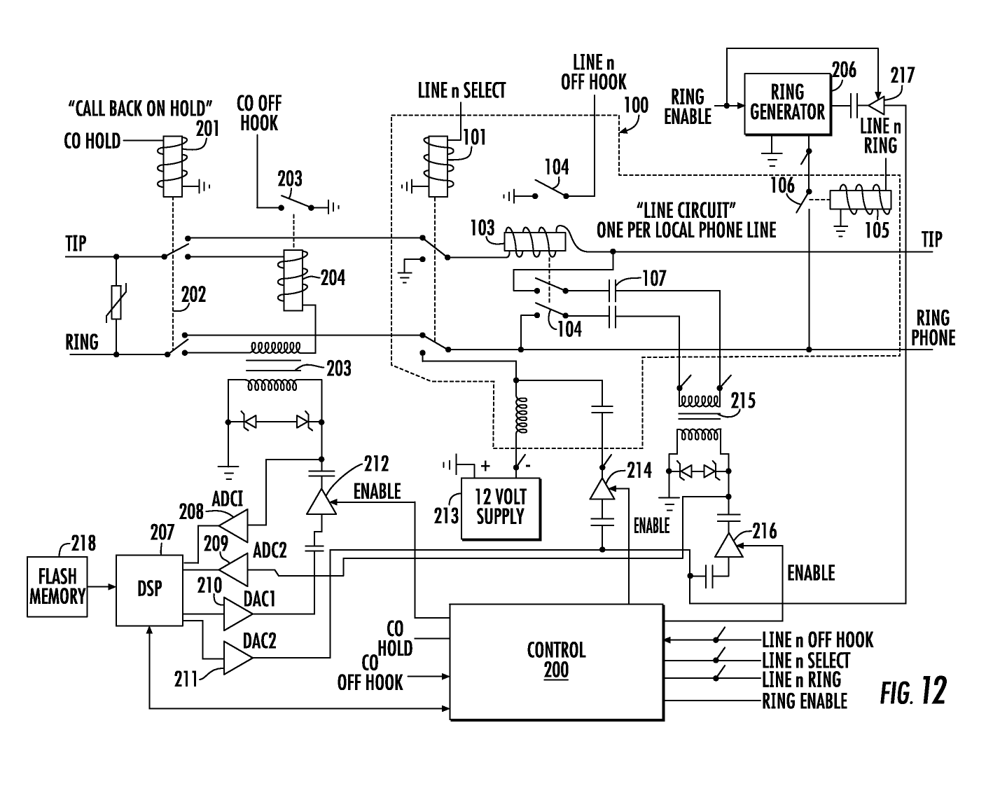

As shown in FIG. 12, any of the above-described embodiments may alternatively be implemented using a dedicated digital signal processor, in the form of a digital signal processing integrating circuit that is separate and apart from the overall control circuitry of the invention. Referring to FIG. 12, the overall circuitry consists of a common section, comprising components 200-218, and a per-line section 100, with components 101-107. Implementations may accordingly have just one line circuit, with multiple phones attached to the Phone side Tip and Ring terminals. However this will limit some of the multi-phone features of the invention. If multiple phones are to be supported, there will preferably be a separate line circuit 100 implementation for each individual phone.

Various call progress, DTMF and ring tones are detected and generated using a Digital Signal Processor (DSP) 207. Included within the DSP, or within associated flash memory 218, is software or firmware to implement the following functionality: a Progress Tone Detector module; a Call Waiting Detector detects the call waiting condition on the line; a DMTF Transceiver module; a Ringback Tone Generator module; a Ringing Tone Generator module; and an Audio Playback module to output audio messages which are stored in Flash Memory 218).

Digital audio tone signals output from DSP 207 are converted to analog signals using associated digital to analog converters (DACs) 210 and 211. The outputs of the DACs are fed into various amplifiers 212, 214 and 216. Analog audio tones are input to the DSP via analog to digital converters (ADCs) 208 and 209.

The hold circuit is shown as 1:1 transformer 203, typically having a DC resistance of a approximately two hundred ohms and an AC impedance of 600 ohms to match the telephone line. Back-to-back Zener diodes are placed across the secondary of hold transformer 203 to limit potentially dangerous voltages from reaching the audio components. Transient protection is also provided by a MOV across the Tip and Ring leads coming from the central office (CO).

Note in the normal state of the circuit (all relays off) there is a straight path from the CO Tip and Ring to each telephone's Tip and Ring leads via normally-closed contacts 202 and 102, with the only extra components in the line being the Line n Off-Hook relays 103 which senses which phone(s) are off-hook.

When a phone is taken off-hook, the appropriate Line n Off-Hook relay 103 will become engaged, putting a ground on the Line n Off-Hook lead via one of its normally-open contacts 104. Two additional normally-open contacts are also closed, connecting the capacitance-coupled transformer 215 which allows the dual-tone multi-frequency (DTMF) receiver module in the DSP to monitor the line for Touch-Tone digits using ADC2 block 209. Normally only one line is connected to the DTMF transceiver at a time, to minimize the parallel impedance placed on the line.

The current-limited 12 volt supply (block 213) is used to supply “talk battery” to the local phone(s) when they are disconnected from the CO line. Each line card includes a choke to isolate the audio and ringing voltage from the battery supply. Control section 200 is implemented using a microcontroller and associated control software or firmware.

In normal call operation, CO Hold relay 201 and the Line Select n relay(s) 101 are both off, and there is a direct path from the CO to the subscriber's phone(s). Assuming just one phone is off-hook, then only one of the Line n Off-Hook relays 103 will be energized, enabling Control logic 200 to determine which phone is taking the call via grounded contact 104. An audio input to DSP 207 is also connected to the line via coupling capacitors 107, transformer 215, and ADC2 209.

If the subscriber is placed on hold by the far end party, and they wish to use the “Callback on Hold” feature, they hit a specific key sequence on their Touch-Tone pad, such as * 8. As the digits are received, they are passed to the Control logic from DTMF Receiver module in the DSP. Alternatively, a dedicated “callback on hold” button may be included within, or ancillary to, a main keypad.

If Control logic 200 determines that the correct sequence of keys has been pressed, then it puts the call on hold by operating CO Hold relay 201, which switches the CO line from the phone to the hold transformer 203 via contacts 202. All local phones are now switched to a local −12 v supply via their Line n Select relays 101 and contacts 102 since the lines are no longer powered from the CO. Once the subscriber hangs up the phone they dialed from, the associated Line n Off-hook relay 103 will disengage and the Line n Off-Hook signal will no longer be grounded via contact 104.

While the CO line is on hold, an audio message (e.g. “Hit any key to resume”) is played via an Audio Playback module portion of DSP 207 via DAC1 210 and amplifier 212 to the far end. Two brief DTMF tone pairs are also sent at the beginning of each of these announcements via a DTMF generator module portion of DSP 207.

If the far-end party takes the call off hold at their end, hears the message and then presses a Touch-Tone key on their phone, the digit will be picked up by the DTMF Receiver module in the DSP (connected via ADC1 208) and passed on to the Control logic. The Control logic will in turn disable the audio playback and send ringback tone via the Ringback Tone Generator module in the DSP using DAC1 210 and amplifier 212 to the far end while it is ringing the local phone(s).

Depending on how the particular system is configured, Control logic 200 can either ring just the phone that originally enabled the Callback on Hold feature, or ring all of the phones connected to the system. Control logic 200 rings the local phone(s) by enabling the appropriate Line n Select and Line n Ring relay(s) 101 and 105. The 20 Hz ringing frequency is generated by DSP 207 and is then fed to DAC2 211 and amplifier 217. It is converted to ringing voltage at 20 Hz 75 v AC and applied to the Ring leads of all of the selected phones via contact 106. The Ring Generator can be made to provide either a standard ring cadence of two seconds on, four seconds off, or a special ring of one second on, two seconds off to indicate a callback, since the timing is controlled by Control logic 200.

If the subscriber answers the phone, one of Line n Off-hook relays 103 will engage causing a Line n Off-Hook signal to be generated via grounded contact 104, and the DTMF Receiver module in DSP 207 will again be connected via ADC2 block 209 to monitor for Touch-Tones. Control logic 200 will then play a recorded message via an Audio Playback module in DSP 207 using DAC2 block 211 and amplifier 216, giving the subscriber the various options available (press * 5, * 1 or * 8). If the user chooses to drop the hold, Control logic 200 will connect all of the phones back to the CO line by dropping all of the Line n Select relays 101, and then dropping the CO Hold relay 201. Once again there will be a direct path from the CO via normally-closed contacts 202 and 102, and at this point the system is back to the original call state it was in before the call was placed on hold. The DTMF Receiver will still be monitoring the line since Line n Off-Hook relay 103 will remain engaged.

While the line is still on hold, if another call comes in and the subscriber has the call waiting feature enabled, then a Call Waiting Detector module of DSP 207 will detect an incoming call waiting condition signal (via ADC1 208) and send a signal to Control logic 200, which in turn will ring the subscriber's phone. When the subscriber answers, the Audio Playback module of DSP will announce that a second call is waiting using DAC2 211 and amplifier 216. After pressing *8 to be connected back to the CO line, the subscriber can then flash the switch hook to connect to the new call. If desired, a different ringing cadence could be used for a call waiting.

While a call is on hold, if the far end party disconnects then the CO will momentarily open the loop for 250-500 ms which is known as the Calling Party Control (CPC) signal. This will cause the CO Off-Hook relay 204 to drop out momentarily, which will be detected by the Control logic via the absence of ground on contact 205. The Control logic will drop the CO Hold relay 201 and any activated Line n Select relays(s) 101, thus making the line available for another call.

If the central office does not provide a CPC signal, then it will send dial tone usually followed by Howler (a.k.a Receiver Off-Hook) tone. This will be detected by the Progress Tone Detector module in DSP 207 via ADC1 208, which will signal Control logic 200 to again drop the CO Hold relay and Line n Select relays(s).

If, while the “Call Back on Hold” feature is engaged (incoming line from CO is being held by relay 204, blocking direct access from the local phones to the CO), a subscriber picks up one of the phones and dials 911, the Control logic will receive the digits 911 via a DTMF Receiver module in DSP 207 via ADC2 209. The Control logic will then drop both the CO Hold and the line select relays (so the phone is now connected to the CO, which will pick the line back up and cause dialtone to be sent). Once dialtone is detected by a Progress Tone Detect module of DSP 207 via ADC2 209, the Control logic will re-send the tones for digits 911 on to the CO via DAC2 211 and amplifier 216.

The second embodiment of the present invention may alternatively be implemented as a standalone device, having its own box, or housing, placed between the subscriber's phone line coming from the central office (CO), and each of their phones. The circuitry employed by the standalone unit is similar to that in the above-described embodiments, minus the dedicated components specific to telephones and answering machines, and consists of a common section, including a CO hold circuit, control logic (or microprocessor), various tone generators and decoders, voice playback units, ringing generator, and power supply; and a per-line section, with line sense and select circuits. The circuitry employed may include a single line circuit, with multiple phones and/or answering machines attachable to the single line circuit in parallel, or may include separate line circuits for each telephone and/or answering machine to be supported. The various tone generators and decoders and voice playback units may be implemented as either separate circuits, or may be implemented via software using a Digital Signal Processor (DSP) or other suitable microprocessor or microcontroller. Moreover, the separate standalone unit may recognize a keypad sequence, such as *8, from any connected telephone handset or answering machine, in order to initiate the call back feature of the present invention. Alternatively, the standalone unit may include a dedicated on-board button, or switch, which may be activated by the user to initiate this process. Moreover, the callback on hold indicator lamp of the present invention, described above, including the use of a different cadence to support the “Hold on Hold Lamp Indication” described above, may be implemented within the housing of the standalone unit.

The DSP/microcontroller of the various embodiments described above may comprise, for example, a DSPIC33FJ64GP802-type 16-bit microcontroller, manufactured by Microchip Technology, Inc. The relays of the various embodiments described above may comprise, for example, G6L-1F DC3-type electromechanical relays, manufactured by Omron Electronic Components LLC. Alternatively, solid-state components may be employed. The ring detect/side tone integrated circuit of the various embodiments described above may comprise, for example, a U4091BM-R-type programmable telephone audio processor integrated circuit, manufactured by Atmel corporation. It should be noted that, depending upon the particular corded, cordless, or cellular telephone of a particular end user, it may be possible to implement the on-hold call back feature of the present invention using a software or firmware upgrade to existing hardware. In other equipment, a hardware upgrade may additionally be necessary. Moreover, as indicated above, an additional stand-alone unit may be employed, without requiring any hardware, firmware, or software modifications to existing equipment.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of construction of the invention disclosed herein without departing from the spirit and scope of the invention. The present disclosure is intended to exemplify and not limit the invention.

1-30. (canceled)

31. A system for one of the parties to a phone call avoiding having to wait on hold for the resumption of a phone call comprising:
a phone system that includes a Digital Signal Processor wherein calls from one party to another are placed on hold;
a first control circuit configured to activate the phone system when a call has been placed on hold so as to provide a call back or signal to the party placed on hold when the call has been taken off hold;
a second control circuit configured to notify the party placing the call on hold that the call can be resumed.

32. The system according to claim 31, wherein the first control circuit comprises a switch.

33. The system according to claim 31, wherein the first control circuit comprises an activation code detector.

34. The system according to claim 31, wherein the first control circuit comprises a dedicated callback on hold button.

35. The system according to claim 31, wherein the first control circuit does not require the cooperation of a central office of a telecommunications company.

36. The system according to claim 31, further comprising an indicator indicating that a hold on hold is in progress.

37. The system according to claim 36, wherein the indicator comprises at least one of a lamp and a light emitting diode.

38. The system according to claim 31, wherein the phone system comprises a combination cordless telephone and answering system.

39. The system according to claim 31, wherein the phone system comprises a cellular telephone.

40. A method for one party to a call to avoid having to wait on hold for the resumption of a phone call comprising:
placing a phone call to another party on hold;
using a central office of a telecommunications system to activate a phone system to provide a call back or signal to the party placed on hold when the call is resumed; and,
notifying the party placing the call on hold that the call can be resumed.

41. The method according to claim 40, wherein the step of activating is performed using a central office switch.

42. The method according to claim 40, wherein the step of activating includes the sub-step of detecting an activation code.

43. The method according to claim 40, wherein the step of activating includes the sub-step of pressing a dedicated callback on hold button.

44. The method according to claim 40, further comprising the step of indicating that a hold on hold is in progress.

45. The method according to claim 40, wherein the step of indicating that a hold on hold is in progress comprises providing an indicator having a cadence alerting a user that they have been placed on hold in response to a prior hold placement.

46. The method according to claim 40, further comprising the step of overriding the system in response to a detection of an emergency call.

47. A method for one party to a call to avoid having to wait on hold for the resumption of a phone call comprising:
placing a phone call to another party on hold;
activating a phone system without requiring the cooperation of a central office of a telecommunications company to provide a call back or signal to the party placed on hold when the call is resumed; and,
notifying the party placing the call on hold that the call can be resumed.
